(19) United States
(12) Patent Application Publication
(10) Pub. No.: US 2023/0042672 A1
(43) Pub. Date: Feb. 9, 2023

(54) PROCESS FOR IMPROVING CREEP AND STRESS RELAXATION OF FIBER REINFORCED POLYMER COMPOSITES

(71) Applicant: United States of America as represented by the Administrator of NASA, Washington, DC (US)

(72) Inventors: Jin Ho Kang, Newport News, VA (US); Keith L. Gordon, Hampton, VA (US); Jeffrey A. Hinkley, Yorktown, VA (US); Sheila A. Thibeault, Hampton, VA (US)

(21) Appl. No.: 17/881,725

(22) Filed: Aug. 5, 2022

Related U.S. Application Data
(60) Provisional application No. 63/229,632, filed on Aug. 5, 2021.

(51) Int. Cl. B32B 5/26; D06M 13/51; B32B 5/02

(52) U.S. Cl. CPC B32B 5/262; D06M 13/51; B32B 5/024; D06M 2101/40

(57) ABSTRACT

Disclosed herein are composite materials comprising a siliconized carbon fiber fabric and polymeric sizing. In one embodiment, the polymeric sizing can be bismaleimide, an epoxy resin, or both. In another embodiment, the composite materials possess mechanical strength and durability and acceptable performance after extended periods of time in storage. In another embodiment, disclosed herein is a method for making the composite materials, the method including at least the steps of (a) siliconizing the carbon fiber fabric to produce a siliconized carbon fiber fabric; and (b) applying a polymeric sizing material to the siliconized carbon fiber fabric to create the composite material. In yet another embodiment, disclosed herein are composite materials formed by the disclosed process and articles comprising the composite materials including, but not limited to, camping equipment, military equipment, clothing, sporting equipment, aerospace equipment, wrinkle-free fabric, or any combination thereof.

### CROSS-REFERENCE TO RELATED PATENT APPLICATION(S)

This patent application claims the benefit of and priority to U.S. provisional patent application 63/229,632, filed on Aug. 5, 2021, the contents of which is hereby incorporated by reference in its entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Carbon fiber reinforced polymer composites have become a standard replacement for metal alloys such as aluminum, titanium, and beryllium copper alloys for aircraft and space structure design due to their light weight, high specific strength, high specific stiffness, lower thermal expansion, and lower life-cycle maintenance due to their superior fatigue and corrosion resistance.

Deployable space structures have been built from carbon fiber reinforced polymer composite materials, but dimensional instability induced by creep or stress relaxation is a critical issue, especially for deployable structures. The inherent viscoelastic behavior of polymers and extended time of stowage between assembly and deployment in space can result in performance degradation of the deployable structures and in the worst case, mission failure.

The creep and stress relaxation of materials originate from the viscoelastic behavior of materials including polymeric materials. Under stress, parts of molecular chains or entire chains rearrange and slide past each other. Generally, thermosetting polymers can be expected to show less creep and stress relaxation compared to thermoplastic polymers due to restriction of chain motions by crosslinking. Particulate additives like silica may also reduce creep. However, previous methods focused on only matrix polymer molecule relaxation with no effort to reduce the creep or stress relaxation induced by and at interfaces between carbon fiber and polymer matrix. In one aspect, high relaxation values are expected if there is poor interfacial interaction between carbon fiber and polymer matrix.

Disclosed herein is a process for improving creep and stress relaxation of fiber reinforced composite by enhanced interfacial strength between fiber and matrix. Applications of the new material include, but are not limited to, inflatable and deployable space structures like solar sails, solar arrays, antennas, payload booms, Mars/Moon habitats, and planetary decelerators. In addition, other potential applications include sports, camping, and military equipment such as racket, golf clubs, ski plats, and deployable habitats.

### BRIEF SUMMARY OF THE INVENTION

Disclosed herein are composite materials comprising a siliconized carbon fiber fabric and polymeric sizing. In one embodiment, the polymeric sizing comprises bismaleimide, polyimide, polyetherimide, polyethersulfone, cyanate ester resin, an epoxy resin, or any combination thereof. In another embodiment, the composite materials possess mechanical strength and durability and acceptable performance after extended periods of time in storage.

In another embodiment, disclosed herein is a method for making the composite materials, the method comprising the steps of (a) siliconizing the carbon fiber fabric to produce a siliconized carbon fiber fabric; and (b) applying a polymeric sizing material to the siliconized carbon fiber fabric to create the composite material.

In yet another embodiment, disclosed herein are composite materials formed by the disclosed process and articles comprising the composite materials including, but not limited to, camping equipment, military equipment, clothing, sporting equipment, aerospace equipment, wrinkle-free fabric, an automobile part, or any combination thereof.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows stress relaxation data of a baseline carbon fiber/novolac epoxy sample ((±45 PW₂/0 UD) layup) at different temperatures and FIG. 1B shows a master curve of relaxation modulus created by a TTS method.

FIGS. 2A-2B show relaxation in modulus of different carbon fiber/polymer composites ((±45 PW₂/0 UD)s layup) at (FIG. 2A) 20° C. in 1 year and (FIG. 2B) 40° C. in 2 years.

FIGS. 3A-3B show relaxation in modulus of different carbon fiber/polymer composites ((±45 PW₂/0-90 PW₂)s layup) at (FIG. 3A) 20° C. in 1 year, and (FIG. 3B) 40° C. in 2 years.

FIGS. 4A-4B show scanning electron microscope (SEM) fracture surfaces images of (FIG. 4A) unmodified carbon fiber/bismaleimide (BMI) composite and (FIG. 4B) modified carbon fiber (organic solvent based epoxy sizing)/BMI composite.

FIG. 5 shows BMI/thin ply carbon fiber (CF) composite coupons cut into bend specimens. Left image: no sizing. Right image: oxidized CF (±45 PW₂/0-90 PW₂) sample.

FIG. 6A shows raw dynamic mechanical analysis (DMA) data for a BMI/CF (no sizing and oxidized (±45 PW₂/0-90 PW₂) sample with the 45 side down while FIG. 6B shows analyzed relaxation moduli based on the raw data.

FIGS. 7A-7B show a comparison of 1-year stress relaxation results for different composites and materials as disclosed herein.

FIGS. 8A-8B show relaxation modulus of BMI/CF composites with no sizing (±45 PW₂/0-90 PW₂ with the 45 PW side down) measured at 0.1% strain (FIG. 8A) and 1% strain (FIG. 8B).

FIG. 9 shows relaxation modulus at 1% strain for BMI/CF with no sizing, (±45 PW₂/0-90 PW₂) sample, with 45 side up, at 120° C.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Disclosed herein are composite materials that include a siliconized carbon fiber fabric and polymeric sizing. In some aspects, the polymeric sizing can be bismaleimide, an epoxy resin, polyimide, polyetherimide, polyethersulfone, cyanate ester resin, or any combination thereof. In one aspect, the epoxy resin can be a novolac epoxy.

In another aspect, the carbon fiber fabric can be or include a plain weave fabric, a unidirectional fabric, or a combination thereof. In one aspect, the carbon fiber fabric can have a (±45 PW₂/0-90 PW₂) structure or a (±45 PW₂/0 UD)s structure. In one aspect, the carbon fiber fabric can have an unmodified tensile strength of about 5490 MPa, an unmodified tensile modulus of about 294 GPa, an elongation of about 1.9%, a density of about 1.73 g/cm³, and a yield of about 760 g/1000 m. In a further aspect, carbon fiber fabrics having other properties can also be used depending on the desired end use of the composite material. In another aspect, one or more of these properties can change when the carbon fiber fabric is incorporated into a composite material as described herein.

In one aspect, the composite materials display low viscoelastic creep and low relaxation due to modification of the carbon fiber/polymeric interfaces. Also disclosed herein are methods for suppressing viscoelastic creep and relaxation using the modified composite materials disclosed herein. Furthermore, disclosed herein are methods for increasing interfacial strength between carbon fiber fabric and a polymeric matrix.

In one aspect, after one year of storage, the composite material has a relaxation in modulus of from about 1% to about 25%, or from about 10% to about 20% compared to a modulus of an identical composite material prior to storage, or of about 1, 2, 3, 4, 5, 6, 7, 8, 9, 10, 11, 12, 13, 14, 15, 16, 17, 18, 19, 20, 21, 22, 23, 24, or about 25%, or a combination of any of the foregoing values, or a range encompassing any of the foregoing values. In one aspect, storage is at a temperature of at least about 20° C., or of at least about 40° C. In another aspect, the composite material has a creep resistance of from about 1% to about 30%, or of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% higher than an otherwise identical composite lacking polymeric sizing, or a combination of any of the foregoing values, or a range encompassing any of the foregoing values.

In another aspect, disclosed herein is a method for making a composite material that includes a carbon fiber fabric, the method including at least the steps of:
(a) siliconizing the carbon fiber fabric to produce a siliconized carbon fiber fabric; and
(b) applying a polymeric sizing material to the siliconized carbon fiber fabric to create the composite material.

In one aspect, siliconizing the carbon fiber fabric includes the step of contacting the carbon fiber fabric with a silane coupling agent and condensing silanol groups from the silane coupling agent with the carbon fiber fabric surface. In another aspect, the silane coupling agent can be hydrolyzed glycidyloxypropyl-trimethoxy silane, (3-aminopropyl)triethoxysilane, (3-aminopropyl)trimethoxysilane, (3-glycidyloxypropyl)trimethoxysilane, methyldiethyoxysilane, vinyltrimethoxysilane, methoxytrimethylsilane, or any combination thereof In another aspect, the composite material includes from about 0.01 to about 0.05 wt % silane coupling agent relative to the weight of the carbon fiber fabric, or about 0.01, 0.015, 0.02, 0.025, 0.03, 0.035, 0.04, 0.045, or about 0.05 wt % silane coupling agent relative to the weight of the carbon fiber fabric, or a combination of any of the foregoing values, or a range encompassing any of the foregoing values. In one aspect, condensing silanol groups from the silane coupling agent with the carbon fiber fabric surface is conducted at from about 100 to about 150° C., or at about 100, 105, 110, 115, 120, 125, 130, 135, 140, 145, or about 150° C., or at about 110° C., or a combination of any of the foregoing values, or a range encompassing any of the foregoing values. In another aspect, the condensing is carried out for about an hour, or for from about 5 minutes to about 3 hours, or for about 5, 10, 15, 20, 25, 30, 35, 40, 45, 50, or 55 minutes, or for about 1, 1.5, 2, 2.5, or about 3 hours, or a combination of any of the foregoing values, or a range encompassing any of the foregoing values.

In still another aspect, in the disclosed method, prior to step (a), the carbon fiber fabric is cleaned in an organic solvent such as, for example, methyl ethyl ketone, toluene, acetone, acetonitrile, benzene, ethanol, hexane, ethyl acetate, xylene, methylene chloride, chloroform, butanol, propanol, ethylene glycol, propylene glycol, ethylbenzene, styrene, pentane, octane, tetrachloroethane, dichloroethane, butyl acetate, methyl ether, ethyl ether, methoxyethanol, ethoxyethanol, butoxyethanol, methyl butyl ketone, methyl iso-butyl ketone, dimethylformamide, dimethyl acetamide, 1-methyl-2-pyrrolidone, dimethyl sulfoxide, dioxane, naphtha, kerosene, or any combination thereof In some aspects, the carbon fiber fabric is cleaned for at least 24 hours. In still another aspect, following cleaning the carbon fiber fabric can be subjected to a thermal treatment at from about 200° C. to about 400° C., or at about 200, 210, 220, 230, 240, 250, 260, 270, 280, 290, 300, 310, 320, 330, 340, 350, 360, 370, 380, 390, or about 400° C., or a combination of any of the foregoing values, or a range encompassing any of the foregoing values. In one aspect, the thermal treatment is at about 250° C. for about 1 hour under an air atmosphere.

In one aspect, applying the polymeric sizing material to the siliconized carbon fiber fabric includes the step of contacting the siliconized carbon fiber fabric with a solution of bismaleimide, polyimide, polyetherimide, polyethersulfone, cyanate ester resin, or any combination thereof. In one aspect, the solution of bismaleimide can be a 1 wt % solution of bismaleimide, or from about 0.1 to about 5 wt % of bismaleimide, or about 0.1, 0.2, 0.3, 0.4, 0.5, 0.6, 0.7, 0.8, 0.9, 1, 1.5, 2, 2.5, 3, 3.5, 4, 4.5, or about 5 wt % bismaleimide, or a combination of any of the foregoing values, or a range encompassing any of the foregoing values. In another aspect, the solution of bismaleimide can be prepared in a solvent such as methyl ethyl ketone, cyclohexanone, acetonitrile, benzene, hexane, xylene, methylene chloride, chloroform, tetrachloroethane, dichloroethane, ethyl ether, methyl butyl ketone, methyl iso-butyl ketone, dimethylformamide, dimethyl acetamide, 1-methyl-2-pyrrolidone, dimethyl sulfoxide, dioxane, or a combination thereof. In another aspect, the bismaleimide solution can include at least one bismaleimide monomer having a molecular weight of from about 1000 to about 40,000 g/mol, or of about 1000, 2000, 3000, 4000, 5000, 6000, 7000, 8000, 9000, 10,000, 15,000, 20,000, 25,000, 30,000, 35,000, or about 40,000 g/mol, or a combination of any of the foregoing values, or a range encompassing any of the foregoing values.

In another aspect, applying the polymeric sizing material to the siliconized carbon fiber fabric includes contacting the siliconized carbon fiber fabric with an epoxy resin solution such as, for example, a 1 wt % solution in methyl ethyl ketone or a 1 wt % emulsion in water. In some aspects, the epoxy resin solution includes difunctional bisphenol A-co-epichlorohydrin (i.e., the bisphenol A-co-epichlorohydrin has two epoxy functional groups).

Also disclosed herein are composite materials formed by the disclosed processes, as well as articles including the disclosed composite materials. In one aspect, the articles can be camping equipment, military equipment, clothing, sporting equipment, aerospace equipment, wrinkle-free fabric, an automobile part, or any combination thereof. In still another aspect, the camping equipment can be an inflatable or deployable camping habitat. In yet another aspect, the military equipment can be a weapon. In one aspect, the article of sporting equipment can be skis, a snow board, gold clubs, a racket, a hockey stick, or a bow. In still another aspect, the article of aerospace equipment can be a payload boom, a solar sail deployer boom, a solar power array, an antenna, a space habitat, a morphing vehicle, a structural rope, an aircraft airframe, or a planetary decelerator. In one aspect, the automobile part can be an automobile chassis.

In any of these aspects, the low viscoelastic properties of the disclosed fiber-reinforced composite materials enables the articles to be durable and mechanically stable, even after one or more years of storage under extreme conditions.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a composite,” “a temperature,” or “an epoxy,” include, but are not limited to, mixtures, combinations, or ranges of two or more such composites, temperatures, epoxies, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x,’ ‘about y’, and ‘about z’ as well as the ranges of ‘less than x’, less than y’, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,’ and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of sizing refers to an amount that is sufficient to achieve the desired improvement in the property modulated by the formulation component, e.g. achieving the desired level of relaxation modulus. The specific level in terms of wt % in a composition required as an effective amount will depend upon a variety of factors including the amount and type of fiber, other materials present, and end use of the article made using the composite.

As used herein, the terms “optional” or “optionally” means that the subsequently described event or circumstance can or cannot occur, and that the description includes instances where said event or circumstance occurs and instances where it does not.

Unless otherwise specified, pressures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.

Aspect 1. A method for making a composite material comprising a carbon fiber fabric, the method comprising:
(a) siliconizing the carbon fiber fabric to produce a siliconized carbon fiber fabric; and
(b) applying a polymeric sizing material to the siliconized carbon fiber fabric to create the composite material.

Aspect 2. The method of aspect 1, wherein siliconizing the carbon fiber fabric comprises contacting the carbon fiber fabric with a silane coupling agent and condensing silanol groups from the silane coupling agent with the carbon fiber fabric surface.

Aspect 3. The method of aspect 1 or 2, wherein the silane coupling agent comprises hydrolyzed glycidyloxypropyl-trimethoxy silane, (3-aminopropyl)triethoxysilane, (3-aminopropyl)trimethoxysilane, (3-glycidyloxypropyl)trimethoxysilane, methyldiethyoxysilane, vinyltrimethoxysilane, methoxytrimethylsilane, or any combination thereof.

Aspect 4. The method of aspect 2 or 3, wherein the composite material comprises about 0.01 wt % to about 0.05 wt % silane coupling agent relative to the weight of the carbon fiber fabric.

Aspect 5. The method of any one of aspects 2-4, wherein condensing silanol groups from the silane coupling agent with the carbon fiber fabric surface is conducted at from about 100° C. to about 150° C.

Aspect 6. The method of any one of aspects 2-4, wherein condensing silanol groups from the silane coupling agent with the carbon fiber fabric surface is conducted at about 110° C.

Aspect 7. The method of any one of aspects 2-6, wherein condensing silanol groups from the silane coupling agent with the carbon fiber fabric surface is carried out for from about 5 minutes to about 3 hours.

Aspect 8. The method of any one of aspects 2-6, wherein condensing silanol groups from the silane coupling agent with the carbon fiber fabric surface is carried out for about 1 hour.

Aspect 9. The method of any one of aspects 1-8, wherein prior to step (a), the carbon fiber fabric is cleaned in an organic solvent.

Aspect 10. The method of aspect 9, wherein the organic solvent is methyl ethyl ketone, toluene, acetone, acetonitrile, benzene, ethanol, hexane, ethyl acetate, xylene, methylene chloride, chloroform, butanol, propanol, ethylene glycol, propylene glycol, ethylbenzene, styrene, pentane, octane, tetrachloroethane, dichloroethane, butyl acetate, methyl ether, ethyl ether, methoxyethanol, ethoxyethanol, butoxyethanol, methyl butyl ketone, methyl iso-butyl ketone, dimethylformamide, dimethyl acetamide, 1-methyl-2-pyrrolidone, dimethyl sulfoxide, dioxane, naphtha, kerosene, or any combination thereof.

Aspect 11. The method of aspect 9 or 10, wherein the carbon fiber fabric is cleaned for at least 24 h.

Aspect 12. The method of any one of aspects 9-11, wherein, following cleaning, the carbon fiber fabric is subjected to thermal treatment at from about 200° C. to about 400° C.

Aspect 13. The method of any one of aspects 9-11, wherein, following cleaning, the carbon fiber fabric is subjected to thermal treatment at about 250° C.

Aspect 14. The method of aspect 13, wherein thermal treatment is conducted for about 1 h under an air atmosphere.

Aspect 15. The method of any one of aspects 1-14, wherein applying the polymeric sizing material to the siliconized carbon fiber fabric comprises contacting the siliconized carbon fiber fabric with a solution of bismaleimide, polyimide, polyetherimide, polyethersulfone, cyanate ester resin, or any combination thereof.

Aspect 16. The method of any one of aspects 1-14, wherein applying the polymeric sizing material to the siliconized carbon fiber fabric comprises of contacting the siliconized carbon fiber fabric with a solution of bismaleimide.

Aspect 17. The method of aspect 16, wherein the solution of bismaleimide comprises from about 0.1 wt % to about 5 wt % bismaleimide in a solvent.

Aspect 18. The method of aspect 16, wherein the solution of bismaleimide comprises of about 1 wt % bismaleimide in a solvent.

Aspect 19. The method of any one of aspects 16-18, wherein the solution of bismaleimide comprises a bismaleimide monomer having a molecular weight of from about 1000 g/mol to about 40,000 g/mol.

Aspect 20. The method of any one of aspects 17-19, wherein the solvent comprises methyl ethyl ketone, cyclohexanone, acetonitrile, benzene, hexane, xylene, methylene chloride, chloroform, tetrachloroethane, dichloroethane, ethyl ether, methyl butyl ketone, methyl iso-butyl ketone, dimethylformamide, dimethyl acetamide, 1-methyl-2-pyrrolidone, dimethyl sulfoxide, dioxane, or any combination thereof.

Aspect 21. The method of any one of aspects 1-14, wherein applying the polymeric sizing material to the siliconized carbon fiber fabric comprises contacting the siliconized carbon fiber fabric with an epoxy resin solution.

Aspect 22. The method of aspect 21, wherein the epoxy resin solution is about a 1 wt % solution in methyl ethyl ketone or about a 1 wt % emulsion in water.

Aspect 23. The method of aspect 21 or 22, wherein the epoxy resin solution comprises difunctional bisphenol A-co-epichlorohydrin.

Aspect 24. A composite material formed by the process of any one of aspects 1-23.

Aspect 25. A composite material comprising a siliconized carbon fiber fabric and polymeric sizing.

Aspect 26. The composite material of aspect 25, wherein the polymeric sizing comprises bismaleimide, polyimide, polyetherimide, polyethersulfone, cyanate ester resin, an epoxy resin, or any combination thereof.

Aspect 27. The composite material of aspect 26, wherein the bismaleimide is polymerized from monomers having a molecular weight of from about 1000 g/mol to about 40,000 g/mol.

Aspect 28. The composite material of aspect 26, wherein the epoxy resin comprises a novolac epoxy.

Aspect 29. The composite material of any one of aspects 25-28, wherein the carbon fiber fabric comprises a plain weave fabric.

Aspect 30. The composite material of any one of aspects 25-29, wherein the carbon fiber fabric comprises a unidirectional fabric.

Aspect 31. The composite material of any one of aspects 25-30, wherein the carbon fiber fabric comprises a (±45 PW₂/0-90 PW₂) structure or a (±45 PW₂/0 UD)s structure.

Aspect 32. The composite material of any one of aspects 25-31, wherein after 1 year of storage, the composite material has a relaxation in modulus of from about 1% to about 25% compared to a modulus of an identical composite material prior to storage.

Aspect 33. The composite material of any one of aspects 25-32, wherein the composite material has a creep resistance of from about 1% to about 30% higher than an otherwise identical composite lacking polymeric sizing.

Aspect 34. The composite material of aspect 32 or 33, wherein storage is at a temperature of at least about 20° C.

Aspect 35. The composite material of aspect 32 or 33, where in storage is at a temperature of at least about 40° C.

Aspect 36. An article comprising the composite material of any one of aspects 24-35.

Aspect 37. The article of aspect 36, wherein the article comprises camping equipment, military equipment, clothing, sporting equipment, aerospace equipment, an automobile part, wrinkle-free fabric, or any combination thereof.

Aspect 38. The article of aspect 37, wherein the camping equipment comprises an inflatable or deployable camping habitat.

Aspect 39. The article of aspect 37, wherein the military equipment comprises a weapon.

Aspect 40. The article of aspect 37, wherein the sporting equipment comprises skis, a snow board, gold clubs, a racket, a hockey stick, or a bow.

Aspect 41. The article of aspect 37, wherein the aerospace equipment comprises a payload boom, a solar sail deployer boom, a solar power array, an antenna, a space habitat, a morphing vehicle, a structural rope, an aircraft airframe, or a planetary decelerator.

Aspect 42. The article of aspect 37, wherein the automobile part comprises an automobile chassis.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The disclosed approach to fabricate novel low creep and low stress relaxation fiber reinforced polymer composites for inflatable and deployable space structures and other articles includes: (1) First, the commercial carbon fiber fabric was cleaned by cleaning in organic solvent, (2) thermal treatment, (3) siliconization of fiber surface, (4) sizing with high temperature polymer, and (5) sizing with epoxy resin.

### Example 1: Relaxation Behavior of Carbon Fiber Reinforced Polymer Composites

The relaxation behavior of carbon fiber reinforced polymer composites was characterized for two polymer matrices, novolac epoxy as a baseline and bismaleimide (BMI) as a low-relaxation polymer. Two different layup configurations of thin-ply, spread-tow carbon fiber plain weave fabric were used as baselines: (±45 PW₂/0-90 PW₂) to represent a small size boom application (e.g. NASA's Advanced Composite Solar Sail System (ACS3) project) and (±45 PW₂/0 UD)s for a large size boom application (e.g. NASA-DLR (the German Aerospace Center) deployable composite boom project). The carbon fiber/BMI composites were prepared by NASA LaRC's composite fabrication technique. All the carbon fiber fabrics were used as received without any further treatment for control data.

### Example 2: Modification of Carbon Fiber Fabrics

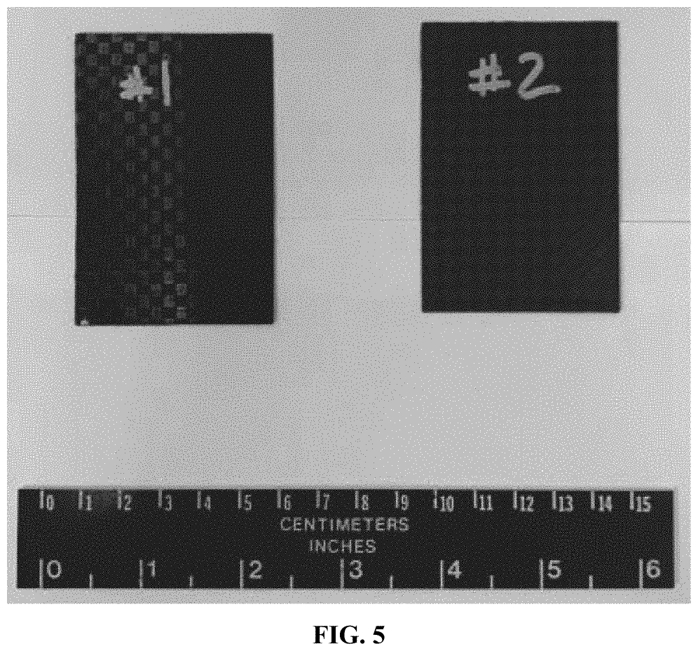

Carbon fiber fabrics were modified with different methods: (1) First, the commercial carbon fiber fabric was cleaned by cleaning in organic solvent such as methyl ethyl ketone (MEK), toluene, and/or acetone for 24 hours. Sample ID was listed as cleaned CF. (2) The cleaned carbon fiber was further thermal treated in a convection oven at 250° C. for 1 hour under air atmosphere. Sample ID was listed as thermal treated CF. (3) The thermal treated carbon fiber was treated with silane coupling agent, hydrolyzed glycidyloxypropyl-trimethoxy silane (GPTMS) aqueous solution to make the surface of carbon fiber siliconized. The 0.1 wt % hydrolyzed GPTMS aqueous solution was prepared by dissolving the GPTMS in acetic acid aqueous solution with pH of 4.5. The treatment time was 30 minutes at room temperature. After silane treatment, the condensation reaction between the silanol groups and carbon fiber surface proceeded at 110° C. under a nitrogen atmosphere for 1 hour. Sample ID was listed as siliconized CF. (4) The siliconized carbon fiber was refinished with 1 wt. % BMI solution in a mixture of MEK/cyclohexanone (1:3 ratio) for 30 minutes and dried at convection oven at 180° C. for 1 minute. Sample ID was listed as BMl sized CF. (5) After the first sizing step, cleaned carbon fiber fabric was also re-sized with 1 wt. % epoxy resin solution such as difunctional bisphenol A-co-epichlorohydrin based epoxy in organic solvent (methyl ethyl ketone, Sample ID: epoxy (O) sized CF) or in water (aqueous emulsion, Sample ID: epoxy (W) sized CF). Exemplary materials are pictured in FIG. 5.

### Example 3: Dynamic Mechanical Analysis of Fiber Reinforced BMI Composites

Different carbon fiber fabric modified with each step in Example 2 were used to make different samples of fiber reinforced BMI composites to compare to the samples made in Example 1. Viscoelastic properties of candidate materials were characterized from storage modulus and loss modulus at a heating rate of 1° C./min and a frequency of 1 Hz using a dynamic mechanical analyzer (DMA, Q800, TA Instruments). A 3-point bending fixture (for composites) were used for measurements.

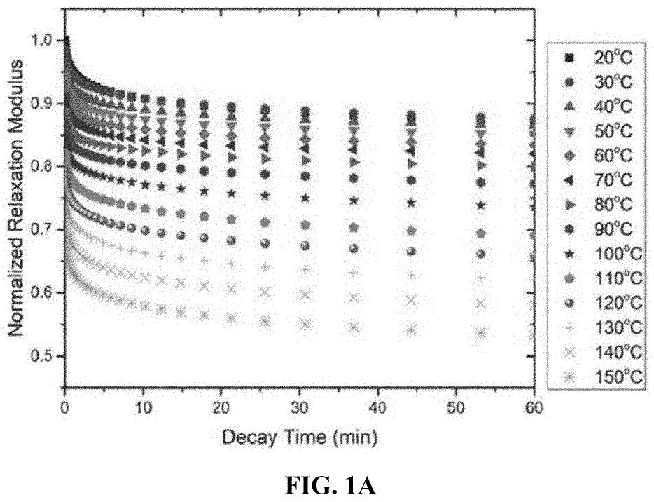

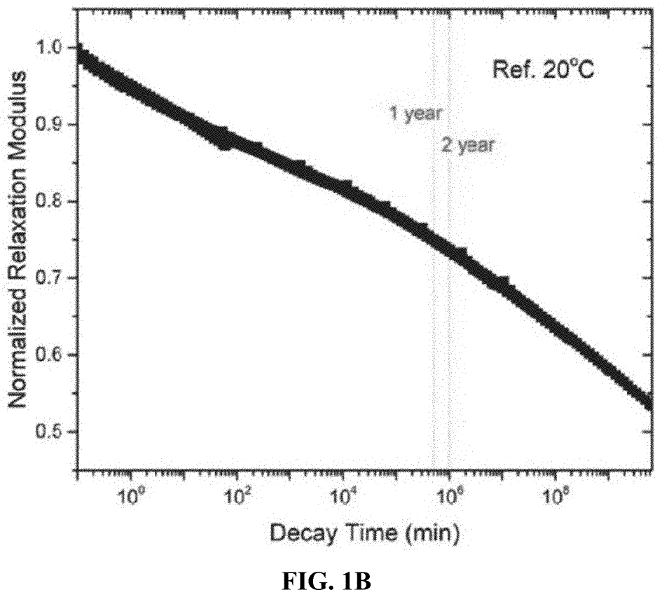

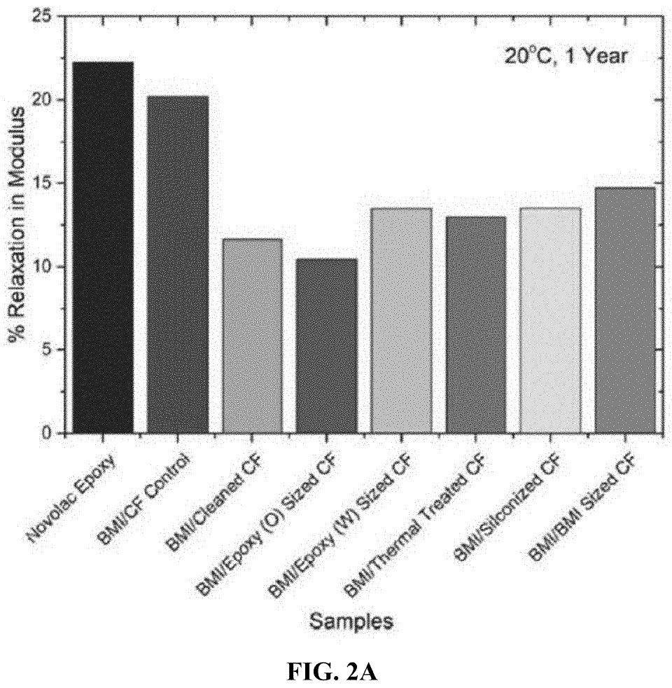

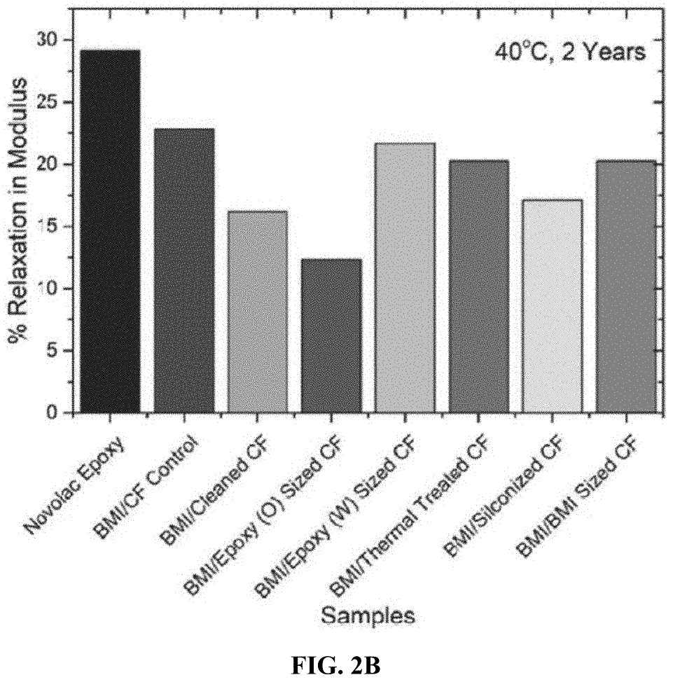

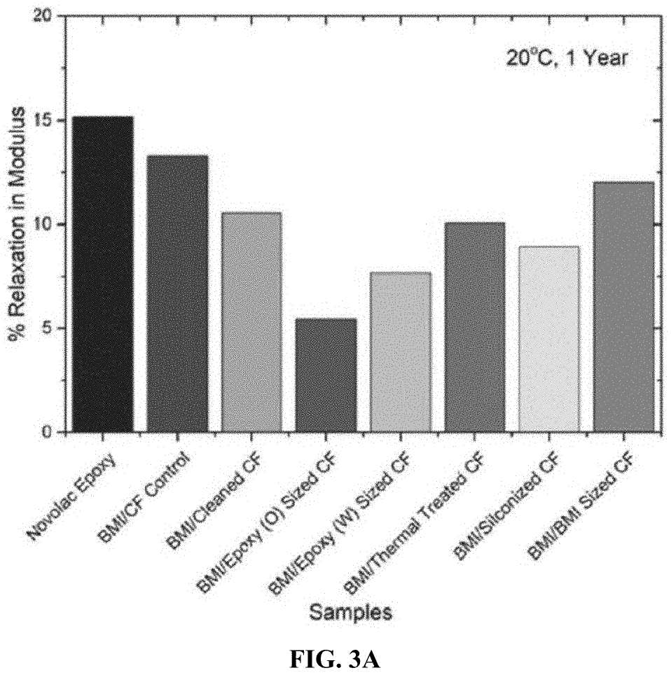

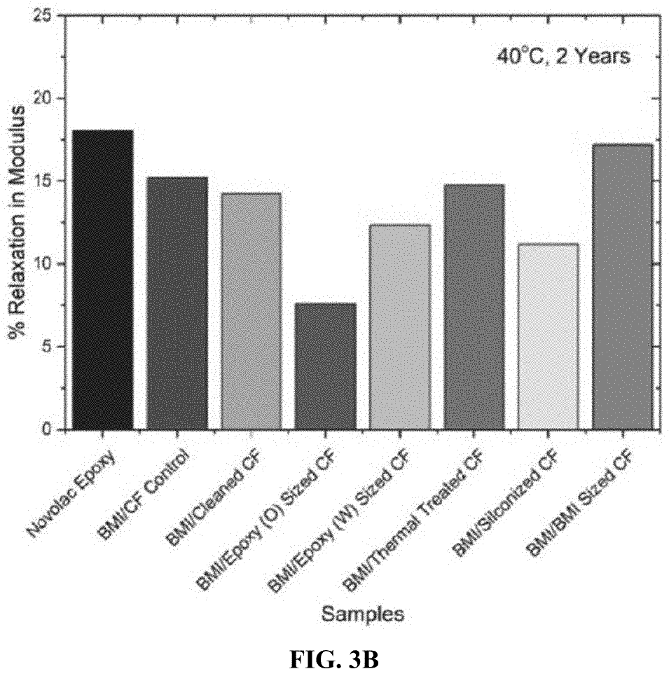

Stress relaxation behavior was characterized from relaxation in modulus at 20° C. to 130° C. in increments of 10° C. At each temperature, load was applied to get a strain of 0.1%. Relaxation was observed for 60 minutes and then the load was removed to allow 10 minutes for strain recovery. In order to predict relaxation in a certain period of time, an accelerated stress relaxation test was performed using the time-temperature superposition (TTS) in the software provided with the DMA instrument to create a master curve and the percent decrease of relaxation modulus at t or 2 years was calculated. An example of creating a master curve is shown in FIGS. 1A-1B. Individual stress relaxation data for the carbon fiber/novolac epoxy sample (±45 PW₂/0 UD)s were obtained at certain temperatures (FIG. 1A) and the individual curves were shifted horizontally to form a continuous master curve as shown in FIG. 1B. The credibility of the master curve was confirmed by a linear relationship between the natural log of the shift factor and inverse temperature (Arrhenius law). The predicted relaxation modulus in 1 year (5.26×10⁵ min) at 20° C. decreased by about 22% from the initial modulus. The relaxation in modulus of the different polymer composites with modified carbon fiber fabric by different methods was plotted in FIGS. 2A-3B. FIG. 2A showed the relaxation in modulus of the carbon fiber layups of (±45 PW₂/0 UD)s/polymer composites in 1 year at 20° C. The baseline polymer composite, novolac epoxy composite showed a relaxation in modulus of about 22% in 1 year at 20° C. When the modified carbon fiber fabric was used, the relaxation in modulus decreased.

The BMI composites fabricated from modified carbon fiber fabric showed about 10 to 15% relaxation in modulus, yielding in about 2-fold improvement compared to baseline epoxy composite and unmodified carbon fiber/BMI composite. The relaxation in modulus in 2 years at 40° C. is shown in FIG. 2B. The modified carbon fiber fabric BMI composite showed about 3-fold improvement in relaxation in modulus compared to the baseline novolac epoxy composite or 2 fold improvement compared to the unmodified carbon fiber/BMI composite. FIGS. 3A-3B shows the relaxation in modulus of the carbon fiber layup of (±45 PW₂/0-90 PW₂)/polymer composite. Overall relaxation in modulus was lower than the (±45 PW₂/0 UD)s layup composites, but the trends are similar. Compared to baseline composites (novolac epoxy and untreated carbon fiber/BMI composite), all the BMI composites fabricated from the modified carbon fiber fabrics showed up to 2-fold improvement in relaxation in modulus. Organic solvent-based epoxy sizing and siliconized carbon fiber composites showed lower relaxation compared to BMI sizing carbon fiber composite.

### Example 4: Scanning Electron Microscopy

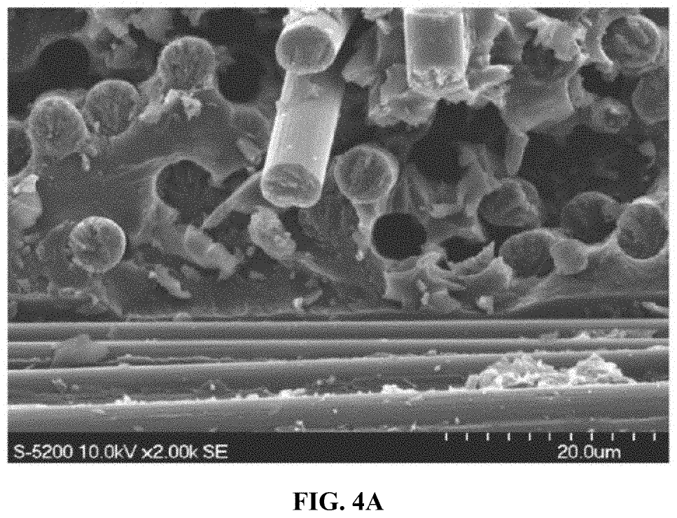

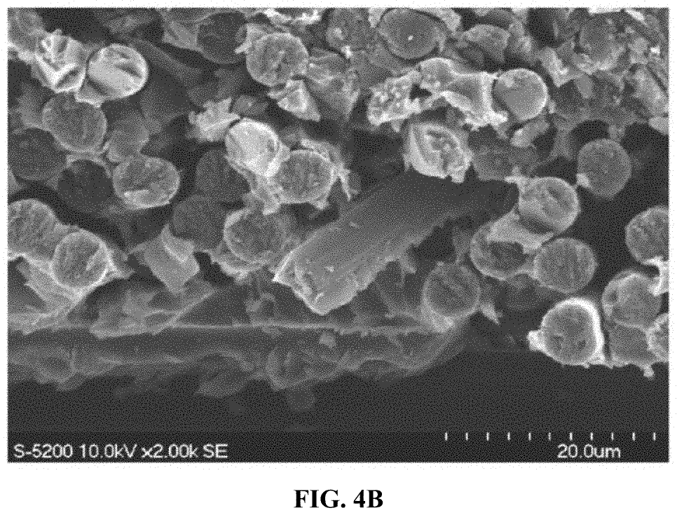

The interfaces of carbon fibers and polymer matrix were investigated using scanning electron microcopy (SEM) after fracture. While the unmodified carbon fibers showed dry and smooth surface after fracture (FIGS. 4A-4B), the carbon fiber modified using organic solvent-based epoxy sizing material showed rough and resin attached indicating stronger interface between carbon fiber and polymer matrix. The improved interfacial strength seems to result in the lower creep and relaxation properties.

### Example 5: Modeling of DMA Results

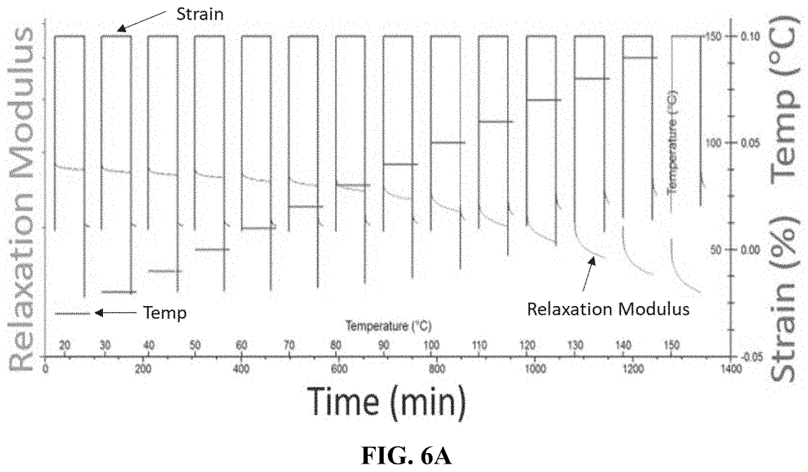

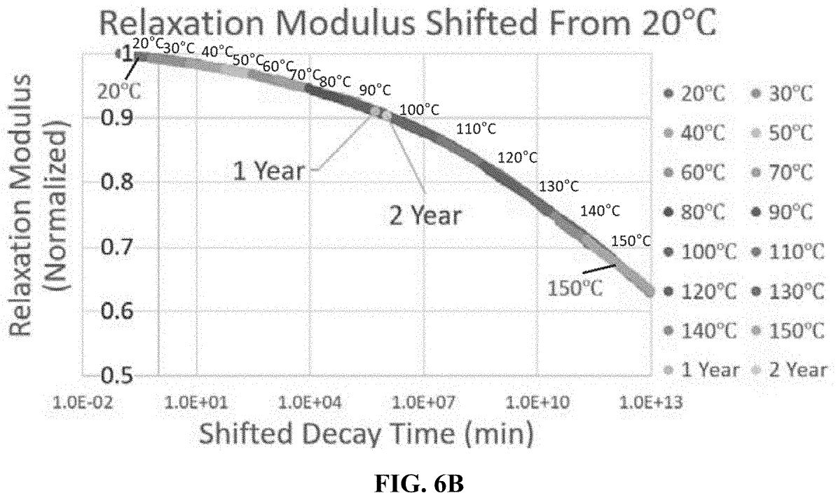

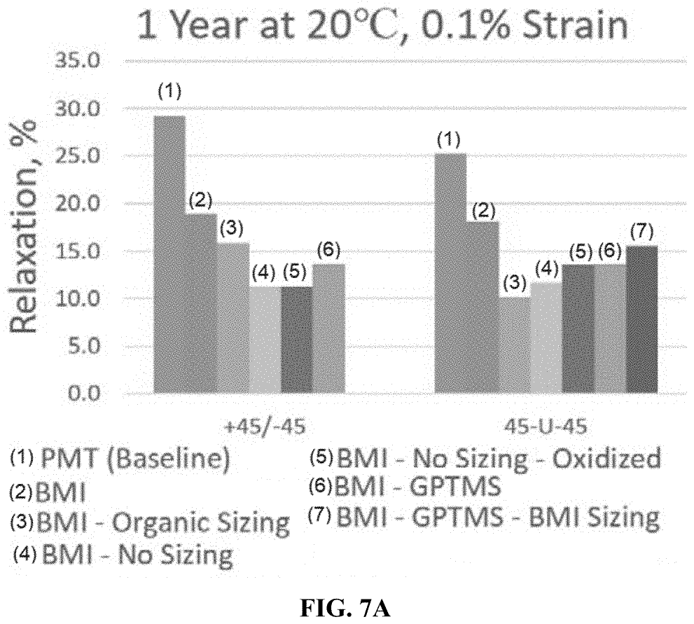

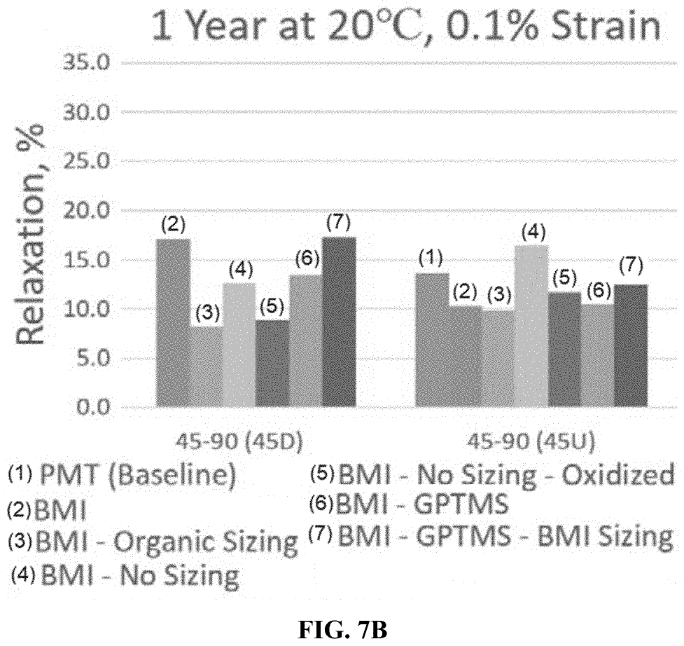

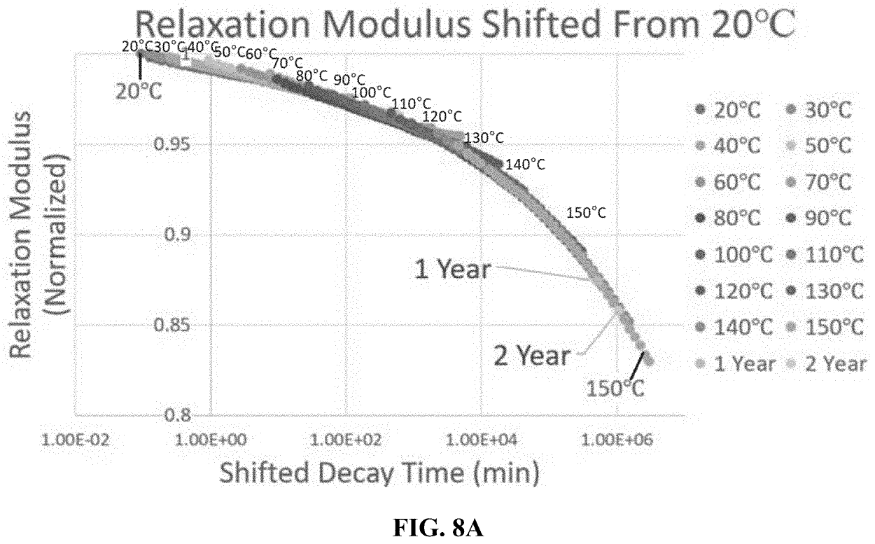

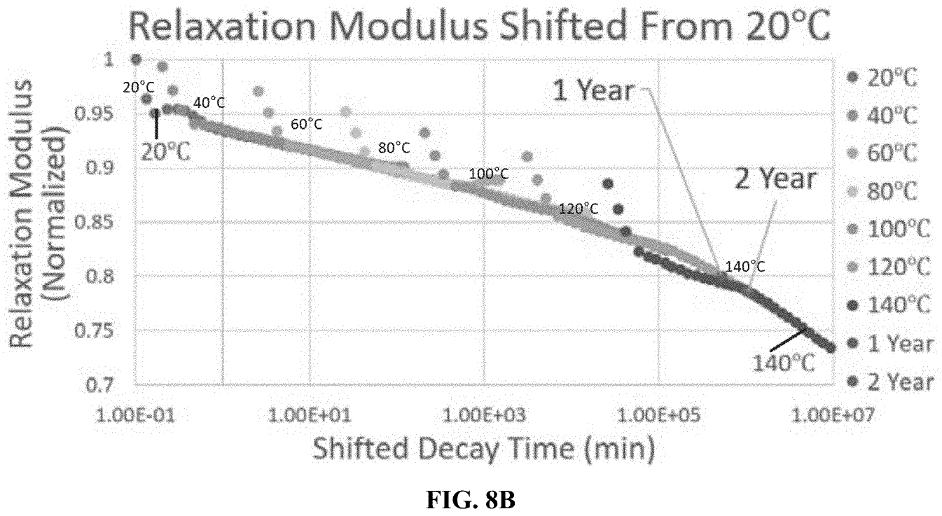

Relaxation curves for the disclosed systems become complex under high strain. Thus, manual generation of temperature-time superposition (TTS) curves was used to predict 1- and 2-year relaxations for the disclosed materials. Raw data from DMA experiments performed as described in Example 3 was shifted horizontally on a log scale by multiplying experiment times by a temperature-dependent shift factor to enable direct comparison of data from experiments conducted under different conditions. Results are shown in FIGS. 6A-8B.

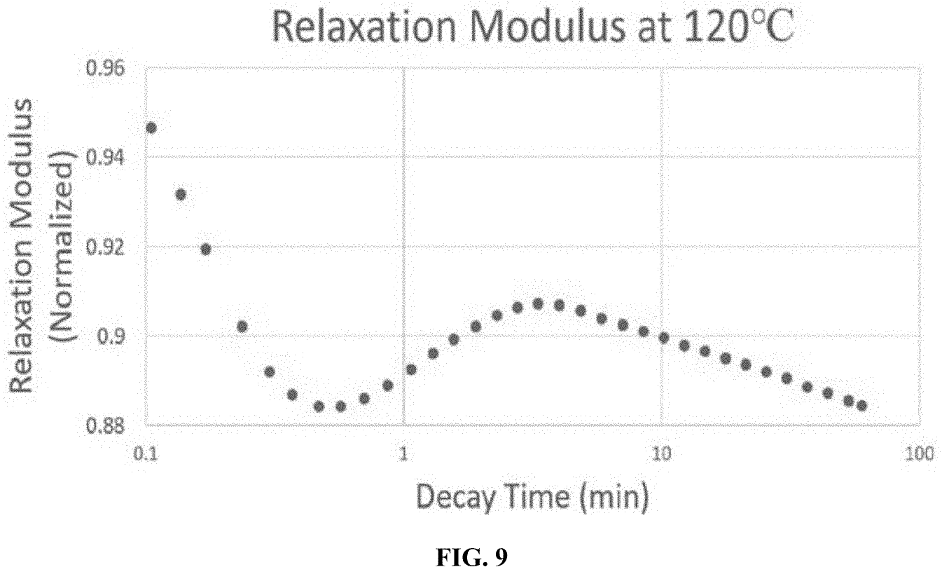

BMI composites showed lower relaxation than baseline PMT F7 epoxy, with surface-modified carbon fiber fabric showing the lowest relaxation of all samples. About 10% average relaxation was observed across all layer configurations for 1 year at 20° C. (for organic solvent-based epoxy). Higher strain tests (i.e. at 1% strain) generated complex curves, suggesting multiple mechanisms of relaxation (see FIG. 9). (0-90 PW)₄ sets showed an increase in modulus with temperature, possibly related to carbon-fiber's thermal properties.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method for making a composite material comprising a carbon fiber fabric, the method comprising:
(a) siliconizing the carbon fiber fabric to produce a siliconized carbon fiber fabric; and
(b) applying a polymeric sizing material to the siliconized carbon fiber fabric to create the composite material.

2. The method of claim 1, wherein siliconizing the carbon fiber fabric comprises contacting the carbon fiber fabric with a silane coupling agent and condensing silanol groups from the silane coupling agent with the carbon fiber fabric surface.

3. The method of claim 1, wherein the silane coupling agent comprises hydrolyzed glycidyloxypropyl-trimethoxy silane(3-aminopropyl)triethoxysilane, (3-aminopropyl)trimethoxysilane, (3-glycidyloxypropyl)trimethoxysilane, methyldiethyoxysilane, vinyltrimethoxysilane, methoxytrimethylsilane, or any combination thereof.

4. The method of claim 1, wherein applying the polymeric sizing material to the siliconized carbon fiber fabric comprises contacting the siliconized carbon fiber fabric with a solution of bismaleimide, polyimide, polyetherimide, polyethersulfone, cyanate ester resin, or any combination thereof.

5. The method of claim 4, wherein applying the polymeric sizing material to the siliconized carbon fiber fabric further comprises contacting the siliconized carbon fiber fabric with an epoxy resin solution.

6. The method of claim 5, wherein the epoxy resin solution comprises difunctional bisphenol A-co-epichlorohydrin.

7. A composite material formed by the process of claim 1.

8. A composite material comprising a siliconized carbon fiber fabric and polymeric sizing.

9. The composite material of claim 8, wherein the polymeric sizing comprises bismaleimide, polyimide, polyetherimide, polyethersulfone, cyanate ester resin, an epoxy resin, or any combination thereof.

10. The composite material of claim 8, wherein the carbon fiber fabric comprises a plain weave fabric.

11. The composite material of claim 8, wherein the carbon fiber fabric comprises a unidirectional fabric.

12. The composite material of claim 8, wherein the carbon fiber fabric comprises a (±45 PW₂/0-90 PW₂) structure or a (±45 PW₂/0 UD)s structure.

13. The composite material of claim 8, wherein after 1 year of storage, the composite material has a relaxation in modulus of from about 1% to about 25% compared to a modulus of an identical composite material prior to storage.

14. The composite material of claim 13, wherein storage is at a temperature of at least about 20° C.

15. An article comprising the composite material of claim 8.

16. The article of claim 15, wherein the article comprises camping equipment, military equipment, clothing, sporting equipment, aerospace equipment, wrinkle-free fabric, an automobile chassis, or any combination thereof.

17. The article of claim 16, wherein the camping equipment comprises an inflatable or deployable camping habitat.

18. The article of claim 16, wherein the military equipment comprises a weapon.

19. The article of claim 16, wherein the sporting equipment comprises skis, a snow board, gold clubs, a racket, a hockey stick, or a bow.

20. The article of claim 16, wherein the aerospace equipment comprises a payload boom, a solar sail deployer boom, a solar power array, an antenna, a space habitat, a morphing vehicle, a structural rope, an aircraft airframe, or a planetary decelerator.
